(19) United States
(12) Patent Application Publication
(10) Pub. No.: US 2015/0092108 A1
(43) Pub. Date: Apr. 2, 2015

(54) ELECTRONIC DEVICE AND METHOD FOR CONTROLLING THE SAME

(71) Applicants: Kabushiki Kaisha Toshiba, Tokyo (JP); Toshiba Lifestyle Products & Services Corporation, Tokyo (JP)

(72) Inventor: Kentaro Okuhara, Fukaya (JP)

(21) Appl. No.: 14/469,317

(22) Filed: Aug. 26, 2014

(30) Foreign Application Priority Data
Sep. 27, 2013 (US) JP2013-201986

(51) Int. Cl. H04N 5/445; H04N 21/41; H04N 21/431; H04N 21/488

(52) U.S. Cl. CPC H04N 5/44591; H04N 21/4882; H04N 21/4131; H04N 21/4316
USPC 348/564

(57) ABSTRACT

According to one embodiment, an electronic device includes, notification type discriminating module, displaying control module and displaying setting module. The notification type discriminating module configured to discriminate a type of a notification received by a notification receiving module. The displaying control module configured to cause a display to display a content of the notification including the time information, based on time information. The displaying setting module configured to set a display format of time information based on a discrimination result of notification type discriminating module.

### CROSS-REFERENCE TO RELATED APPLICATIONS

This application is based upon and claims the benefit of priority from Japanese Patent Application No. 2013-201986, filed Sep. 27, 2013, the entire contents of which are incorporated herein by reference.

### FIELD

Embodiments described herein relate generally to an electronic apparatus and a displaying method.

### BACKGROUND

Operations of ECHONET Lite (Energy Conservation and Homecare Network; hereinafter called ECHONET protocol established by ECHONET CONSORTIUM) have been started as an Internet standard on communications between daily life related household electrical appliances (hereinafter household electrical appliances) such as refrigerators, washing machines and lighting apparatuses and electronic apparatus capable of displaying images, such as television receivers and monitors connected with recorders, and apparatuses conforming to the standard are available.

By receiving a notification (information) from an apparatus conforming to ECHONET Lite by means of an electronic apparatus and displaying the result, for example, indicating on a screen of a television receiver, etc. that the operations of a household electrical appliance have been ended, a user can recognize operation conditions or occurrence of trouble in the household electrical appliance while viewing a content (program) by the television receiver.

To the contrary, the television receiver which can receive the notification from the household electrical appliance is often unable to display the notification from the household appliance on the display, for example, upon turning off of light on the screen in a standby state, acquisition and reproduction of a content from a network, etc.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary diagram showing an example of a system configuration according to an embodiment;

FIG. 2 is an exemplary diagram showing an example of the system configuration according to an embodiment;

FIG. 3 is an exemplary diagram showing an example of the system configuration according to an embodiment;

FIG. 4 is an exemplary diagram showing an example of acquired information in the system according to an embodiment;

FIG. 5 is an exemplary diagram showing an example of acquired information in the system according to an embodiment;

FIG. 6 is an exemplary diagram showing an example of a screen display (on a displaying apparatus) according to an embodiment;

FIG. 7 is an exemplary diagram showing an example of a screen display (on the displaying apparatus) according to an embodiment;

FIG. 8 is an exemplary diagram showing an example of a screen display (on the displaying apparatus) according to an embodiment;

FIG. 9 is an exemplary diagram showing an example of a screen display (on the displaying apparatus) according to an embodiment;

FIG. 10 is an exemplary diagram showing an example of software for a displaying method in the displaying apparatus according to an embodiment;

FIG. 11 is an exemplary diagram showing an example of software for a displaying method in the displaying apparatus according to an embodiment;

FIG. 12 is an exemplary diagram showing an example of an electronic apparatus applicable to the embodiment according to an embodiment; and

FIG. 13 is an exemplary diagram showing an example of an electronic apparatus applicable to the embodiment according to an embodiment.

### DETAILED DESCRIPTION

Various embodiments will be described hereinafter with reference to the accompanying drawings.

In general, according to one embodiment, an electronic device comprises: a notification receiving module, a notification holding module, a notification type discriminating module, a displaying control module and a displaying setting module. The notification receiving module configured to receive a notification from a counterpart communication apparatus. The notification holding module configured to acquire time information that the notification receiving module has received the notification and to hold the time information in association with the notification. The notification type discriminating module configured to discriminate a type of the notification received by the notification receiving module. The displaying control module configured to cause a display to display a content of the notification including the time information, based on the time information. The displaying setting module configured to set a display format of the time information based on a discrimination result of the notification type discriminating module.

Embodiments will now be described hereinafter in detail with reference to the accompanying drawings.

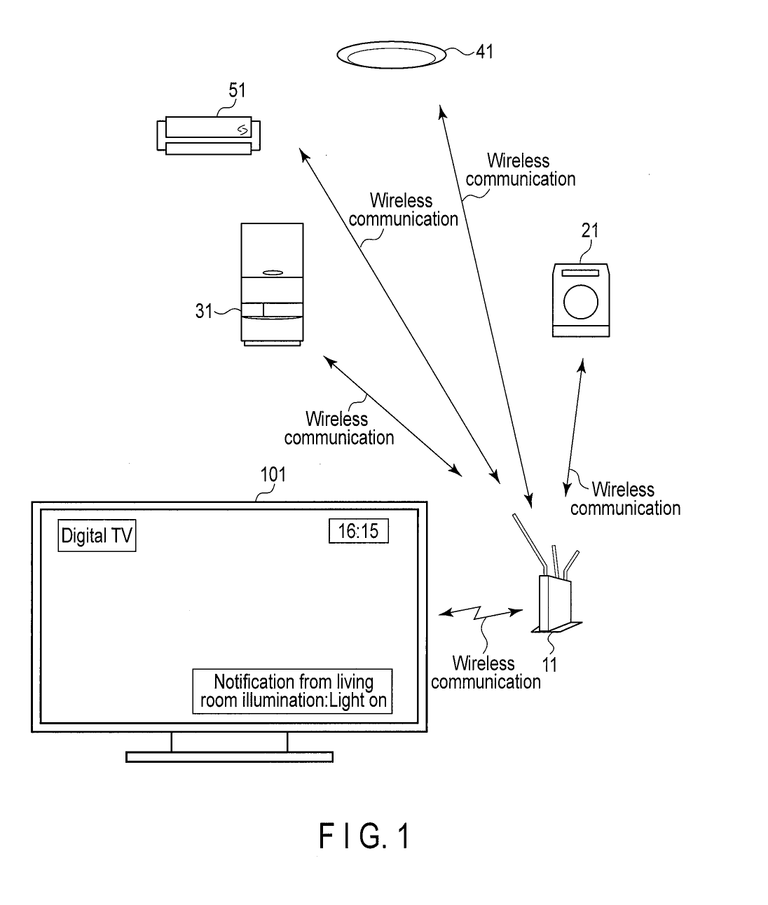

FIG. 1 shows an example of a home network system configured by an electronic apparatus such as a digital television receiving and reproducing apparatus (hereinafter called television apparatus) 101, an access point (Wi-Fi communication controller) 11 configured to communicate with the television apparatus 101 and an external network (Internet) 1, and daily life related household electrical appliances (hereinafter household electrical appliances) 21, 31, 41 and 51 capable of notifying the access point 11 of an own operation state.

In FIG. 1, one of the household electrical appliances is, for example, a washing machine 21 which is capable of completion notification of, for example, completion of washing, etc., and error notification of, for example, an operation trouble(s) in an operating state such as dehydration or the like. In addition, another one of the household electrical appliances is, for example, a refrigerator 31, which notifies an unfavorable operation such as a half opened state of a door (incomplete closing of door), an opened state of a door (radical rise in inside temperature) or the like. Yet another one of the household electrical appliances is, for example, a lighting apparatus 41, which notifies a state associated with a switch such as turning on/off. Yet another one of the household electrical appliances is, for example, an air-conditioner 51, which notifies, for example, a time for cleaning or a trouble (troubles) based on a self-diagnostic function (error notification). Each of the household electrical appliances 21, 31, 41 and 51 notifies the own operation state of the television apparatus 101 by a prepared communication unit/communication controller, based on processing (control) corresponding to ECHONET Lite standard.

In FIG. 1, each of the household electrical appliances 21, 31, 41 and 51 comprises the communication unit/communication controller capable of wireless communication (notification of the own operation state to the access point 11) with the access point 11. The communication unit/communication controller, preferably, should be, for example, a Wi-Fi communication module conforming to IEEE (Institute of Electrical and Electronics Engineers) 802.11 (x; x indicates a division of b/g/n, etc.) or a Bluetooth communication module of a Bluetooth (registered trademark) standard conforming to IEEE (Institute of Electrical and Electronics Engineers) 802.15.1.

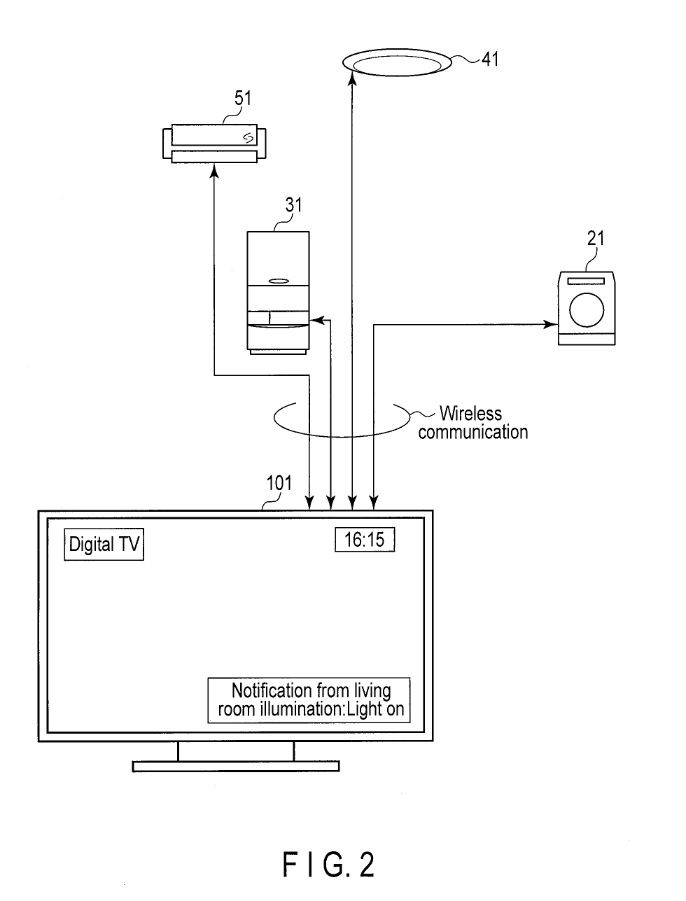

FIG. 2 shows an example that each of the household electrical appliances 21, 31, 41 and 51 is capable of directly notifying the television apparatus 101 of its own operating state by wireless communication in the same home network system comprising the household electrical appliances 21, 31, 41 and 51 as the example shown in FIG. 1.

In the example shown in FIG. 2, each of the household electrical appliances 21, 31, 41 and 51 comprises, for example, a communication unit/communication controller of a Wi-Fi direct (near field communication) system. The communication unit/communication controller may conform to, for example, a Bluetooth (registered trademark) standard conforming to IEEE (Institute of Electrical and Electronics Engineers) 802.15.1.

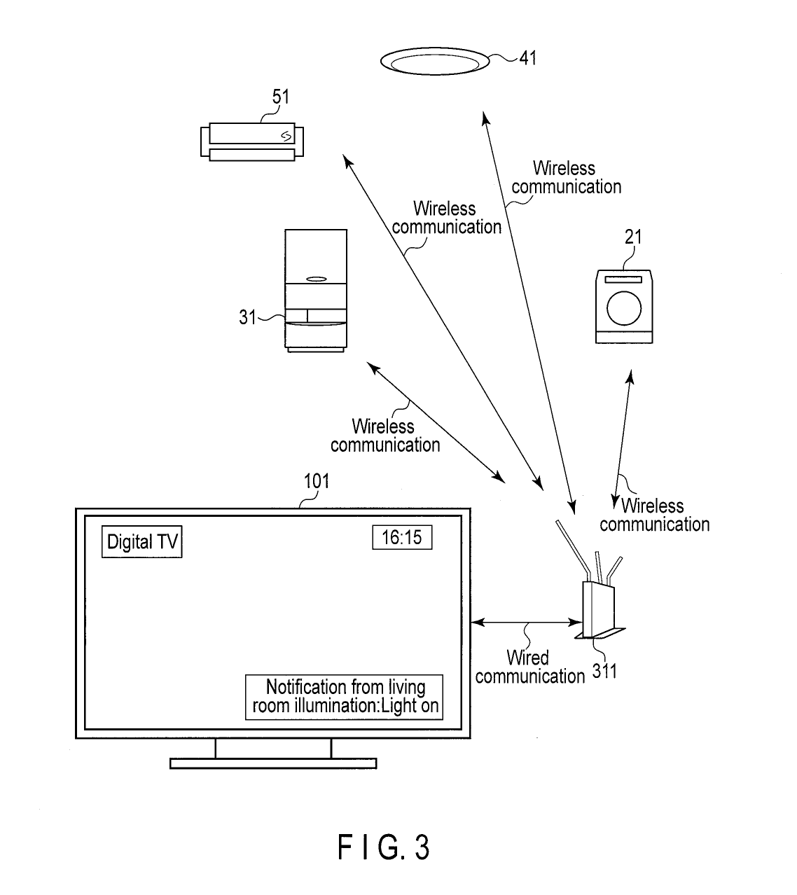

FIG. 3 shows an example in which the television apparatus 101 is directly connected with a router 311 by wired communication, and a wireless communication module (access point) connected with the router 311 (or built in the router 311) and each of the household electrical appliances 21, 31, 41 and 51 are capable of directly notifying each other of its own operating state by wireless communication, in the same home network system comprising the household electrical appliances 21, 31, 41 and 51 as the example shown in FIG. 1.

In the example shown in FIG. 3, communication between each of the household electrical appliances 21, 31, 41 and 51 and the router 311 (access point) is wireless communication, and communication between the router 311 and the television apparatus 101 is wired communication conforming to an Ethernet (registered trademark) system represented by, for example, X-Base-TX/T (X is an identification name of either 100 or 1000, and TX/T is a code determined by combination with the identification name).

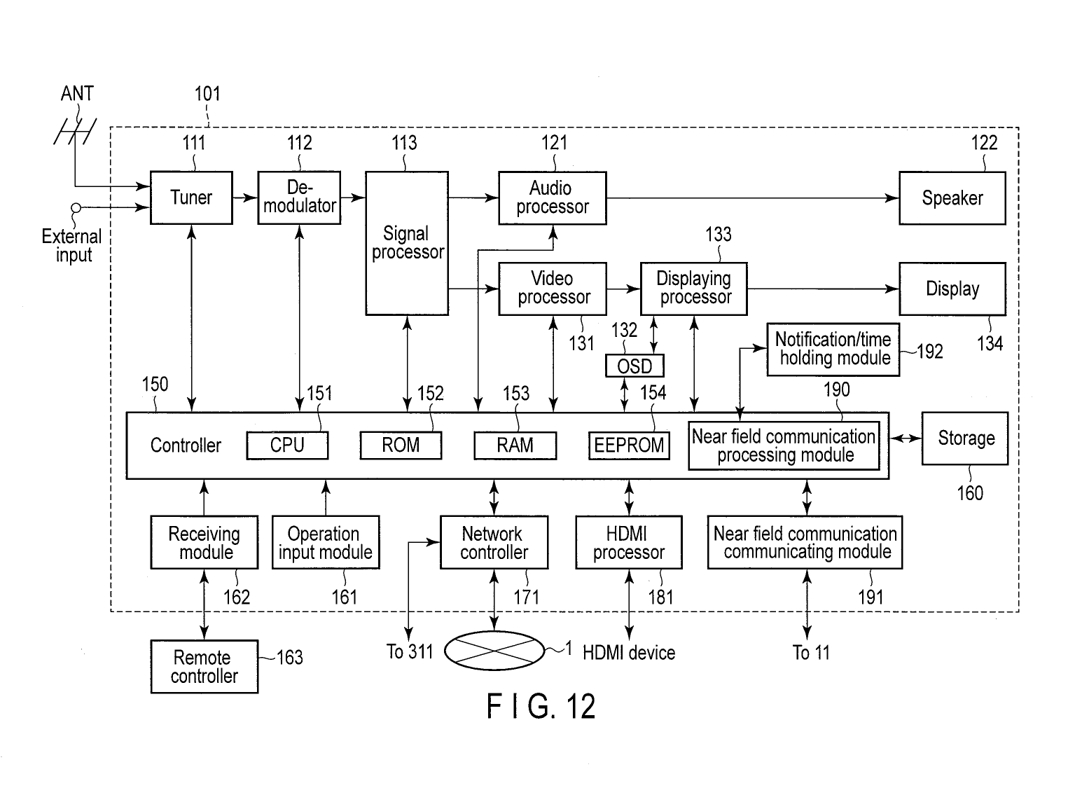

An example of the television apparatus 101 shown in FIG. 1 to FIG. 3 is shown in FIG. 12. However, any apparatus comprising, for example, a user interface, a wireless or wired communication function (for example, Bluetooth (registered trademark), or near field communication of the WiFi (Wireless Fidelity) direct and communication with outside via a network (Internet)), a function of receiving broadcast, a processing function of processing the received broadcast, i.e., a program, a program output function of outputting the program, a storing (recording) function, etc. may be the television apparatus 101. The apparatus can be applied to a PC (personal computer) having the function of receiving the broadcast, an image displaying apparatus (monitor) connected with an image recording apparatus (recorder) comprising a broadcast receiver, a portable terminal apparatus comprising the broadcast receiving function, etc. The broadcast implies broadcast provided as radio waves propagating space by a broadcaster (broadcast station), broadcast distributed via a network such as a cable or an IP (Internet protocol) network by a distributor, etc. In addition, the broadcast implies an image, speech and/or music, etc., and provides programs in unit of a certain time (broadcast time), sequentially or for a certain period (time). The program is often called content, or a stream. The image implies a moving image, a still image, or a text (information represented by characters, symbols, etc. indicated by a coded code string), and an optional combination thereof.

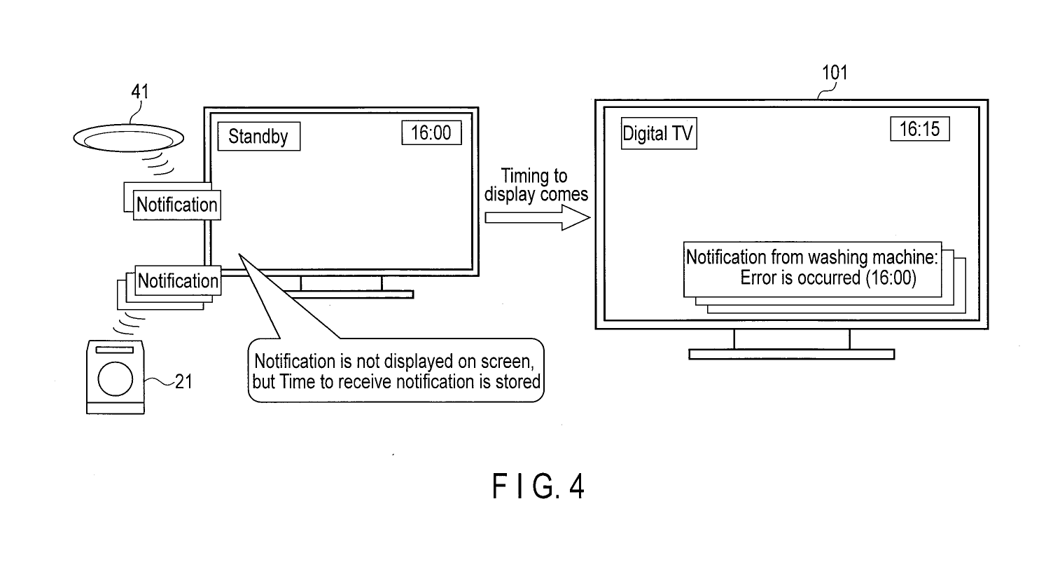

FIG. 4 shows an example in which any one of the household electrical appliances 21, 31, 41 and 51, for example, the washing machine 21 and the lighting apparatus 41 notify the television apparatus 101 of their own operating states, based on processing (control) conforming to ECHONET Lite standard. The television apparatus 101 can receive a notification from the household electrical appliances but cannot often display the notification on the display, for example, at operations of reception (acquisition from the network) of a video on demand (VOD) content and reproduction (image display and speech reproduction), or during viewing a Web page in the network.

It is assumed that the television apparatus 101 receives a notification from the washing machine 21 at [16:00], for example, during reproduction of the VOD content, in FIG. 4. For example, when the television apparatus 101 ends reproduction of the content at [16:15] and shifts to a state of being capable of displaying the notification (receiving a general broadcast or the like), the television apparatus 101 simultaneously displays the stored time [16:00] and a content of the notification.

More specifically, if a notification is received in an operating state of being incapable of displaying the notification by a notification holding module (corresponding to, for example, a notification/time holding module 192 in the television apparatus 101 shown in FIG. 12), the time at which the notification is received (reception time) is stored in association with the notification. Since the notification does not include time information, a time of the television apparatus 101 (for example, a time acquired/maintained by a clock function using a clock of a controller 150 in the television apparatus shown in FIG. 12 or a clock module built in the television apparatus) is used as the time to be stored (reception time).

After that, at a timing at which the notification (held by the notification holding module) received from the household electrical appliances can be displayed, the television apparatus 101 simultaneously displays the stored time and the notification on the screen.

The example shown in FIG. 4 is a notification called “trouble notification (first-type notification)” for convenience, and it is preferable that the time at which the notification has been received should be displayed as it is. The user can easily presume a reason for the trouble by knowing the time at which the notification has been received (i.e., the user could understand the reason for the trouble from the time information).

The “trouble notification (first-type notification)” and “completion notification (second-type notification)” are classified in view of properties to be read and contents.

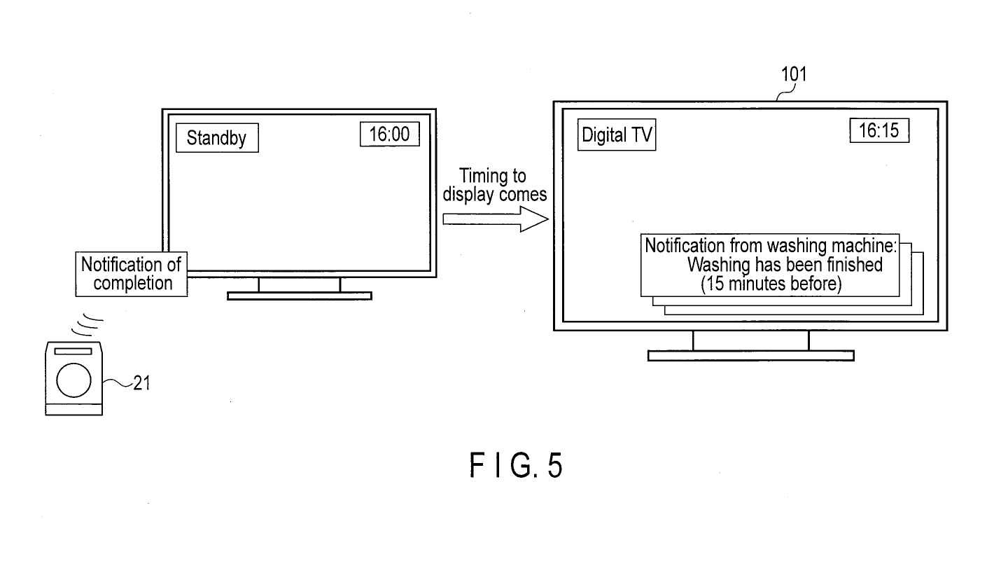

FIG. 5 shows a display example of the “completion notification (second-type notification)”.

If the notification received from the household electrical appliance and held by the notification holding modules is, for example, “washing finished” which notifies finish of washing at the washing machine 21, not the stored time, but the time elapsing after the stored time, i.e., “time to elapse” from the (current) time at a time to be displayed can also be displayed, as shown in FIG. 5. In other words, if the notification “washing finished” from the washing machine 21 is displayed, selection of this type (“washing finished (15 minutes ago)” indicating the elapsing time) is preferable since the time which has elapsed from the finish of washing is important information for the user. During reproduction of a recorded content (program), for example, the elapsing time can be easily obtained from reproducing position information (time information) of the content. The elapsing time can be acquired (computed) by, for example, comparing time information obtained as the reproducing position information at the time when the notification is received with time information which can be understood from the current reproducing position information.

The elapsing time can be easily obtained based on the time information at the time when the notification is received (the above-described clock function or time) and the time information at the time when the notification becomes displayable (for example, a CPU 151 of a controller 150 in the television apparatus shown in FIG. 12 can easily compute the elapsing time by, for example, firmware). Of course, an exclusive elapsing time computing module can be prepared and used.

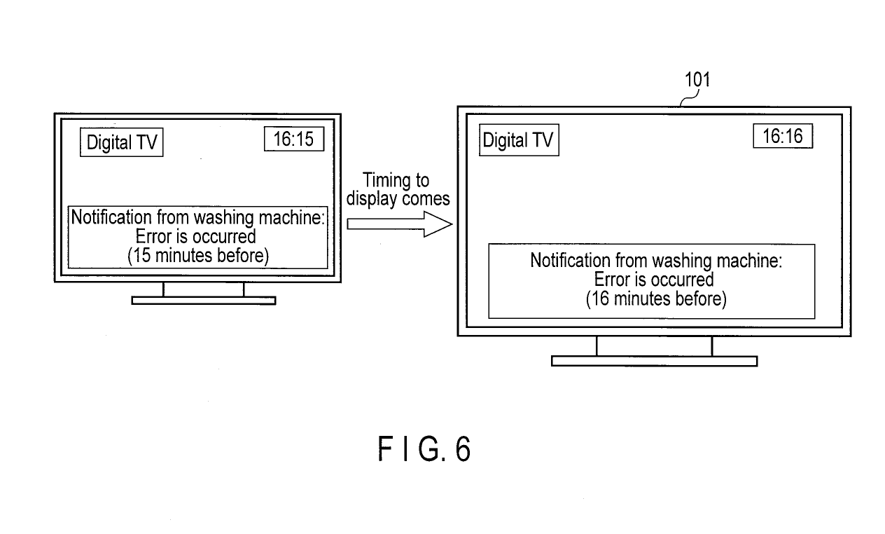

In addition, then the elapsing time is displayed, the elapsing time may be successively summed (counted up) and displayed, in association with the current time, as shown in FIG. 6. In the example shown in FIG. 6, “ . . . (16 minutes ago)” is displayed at a time when one minute further elapses after “ . . . (15 minutes ago)” is displayed at [16:15] at which the stored time [16:00] becomes capable of being displayed.

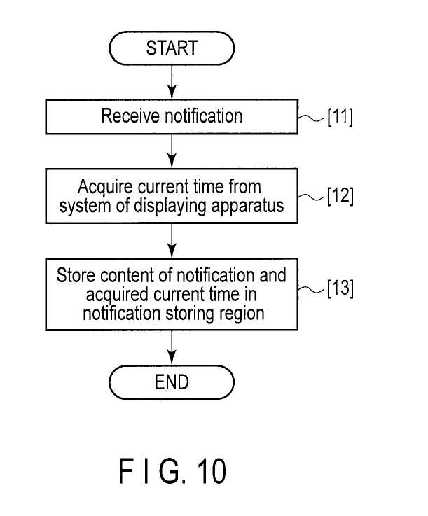

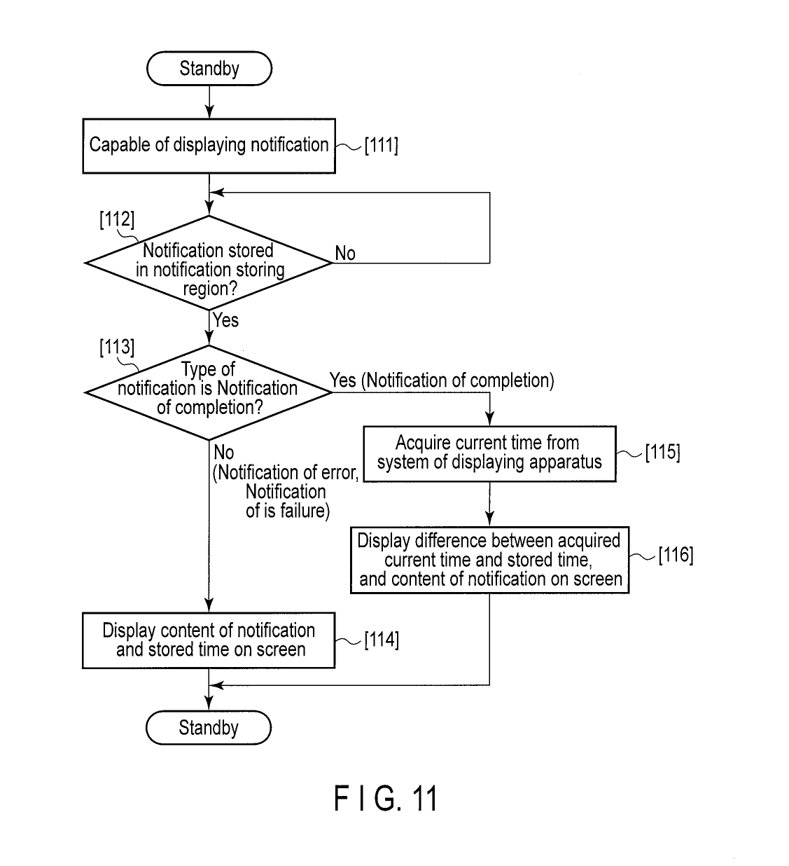

FIG. 10 and FIG. 11 show the reception (acceptance)/storing of the notification from the household electrical appliances shown in FIG. 3 to FIG. 5, and the time display at the time when the television apparatus becomes capable of displaying the notification after accepting the notification, as software.

As shown in FIG. 10, a notification indicating a state of the apparatus is accepted from an arbitrary household electrical appliance (ECHONET Lite conforming apparatus) [11].

The television apparatus (displaying apparatus) obtains the time at which the notification has been accepted from the clock or clock module [12].

The displaying apparatus (television apparatus) stores the accepted notification and the time when the notification has been accepted in a notification storing region [13].

FIG. 11 shows selection of the displaying manner of displaying the notification held in the notification storing region (notification holding module).

It is checked whether the notification storing region (notification holding module) holds the notification or not at the time [111] when the displaying apparatus (television apparatus) becomes capable of displaying the notification [112].

If the notification storing region (notification holding module) holds the notification [112-YES], the notification type is checked [113]. For example, it is checked whether the notification type is the “trouble notification (first-type notification)” or the “completion notification (second-type notification)”.

If the notification type is the “trouble notification (first-type notification)” [113-NO], the notification content and the stored time are displayed on the screen of the displaying apparatus (television apparatus) [114].

If the notification type is the “notification of completion (second-type notification)” [113-YES], the current time is obtained [115], and a difference (elapsing time) between the obtained time and the stored time and the notification content are displayed on the screen of the displaying apparatus (television apparatus) [116]. In the error notification, too, the time is displayed similarly to the “notification of trouble (first-type notification)”.

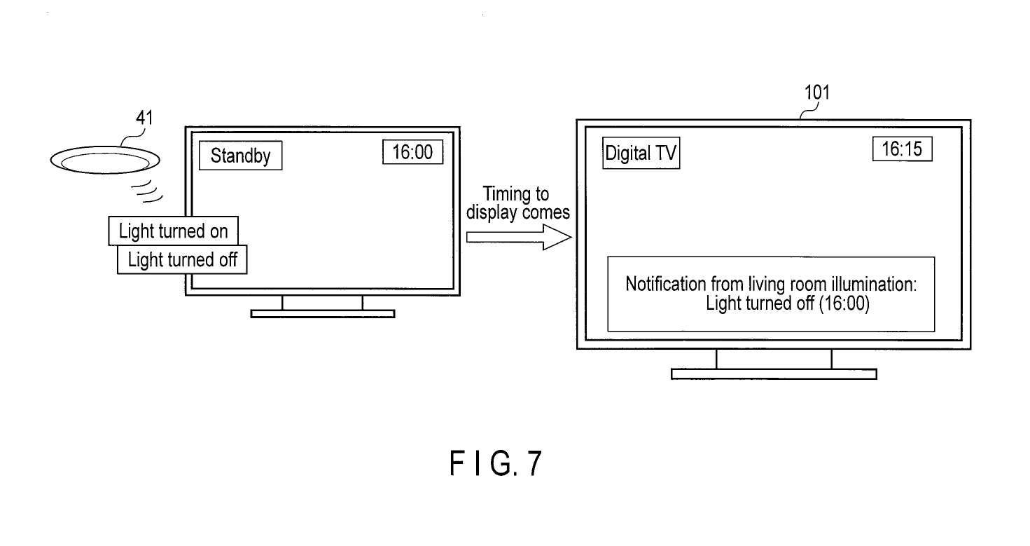

FIG. 7 to FIG. 9 show various displaying examples of the method of displaying the notification received from the household electrical appliances (ECHONET Lite conforming apparatuses) by the television apparatus (displaying apparatus).

As shown in FIG. 7, for example, if the television apparatus (displaying apparatus) receives a notification “light turned on” and then receives a notification “light turned off” from the lighting apparatus 41 in a period in which the notifications cannot be displayed, and becomes at the timing of being capable of displaying, the television apparatus (displaying apparatus) can also display the last notification “light turned off” alone. In other words, if the television apparatus (displaying apparatus) receives a plurality of notifications from the same apparatus in a period in which the notifications cannot be displayed, the notifications can be displayed in an order of receiving the notifications, but the last result alone often needs to be recognized. In this case, the last (latest) notification alone may be displayed as shown in FIG. 7. The apparatus displaying the last (latest) notification alone is specified, depending on the apparatus type. The apparatus type can easily be specified based on, for example, a media access control (MAC) address. According to ECHONET Lite, the apparatus type can be identified based on the MAC address.

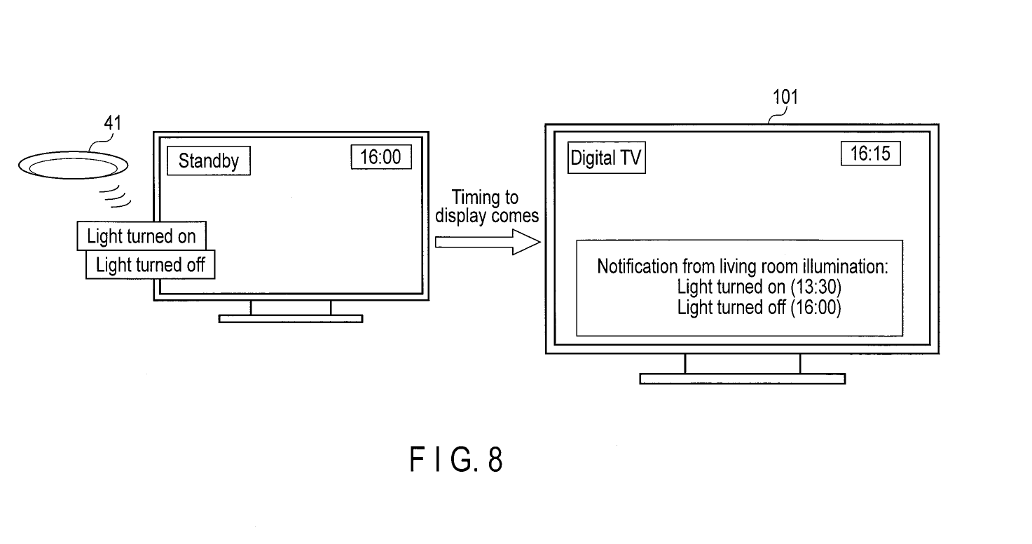

If the television apparatus (displaying apparatus) receives a plurality of notifications from the same apparatus in a period in which the notifications cannot be displayed, a list of history of the plurality of notifications received from the same apparatus can also be displayed in the notification displaying region, as shown in FIG. 8.

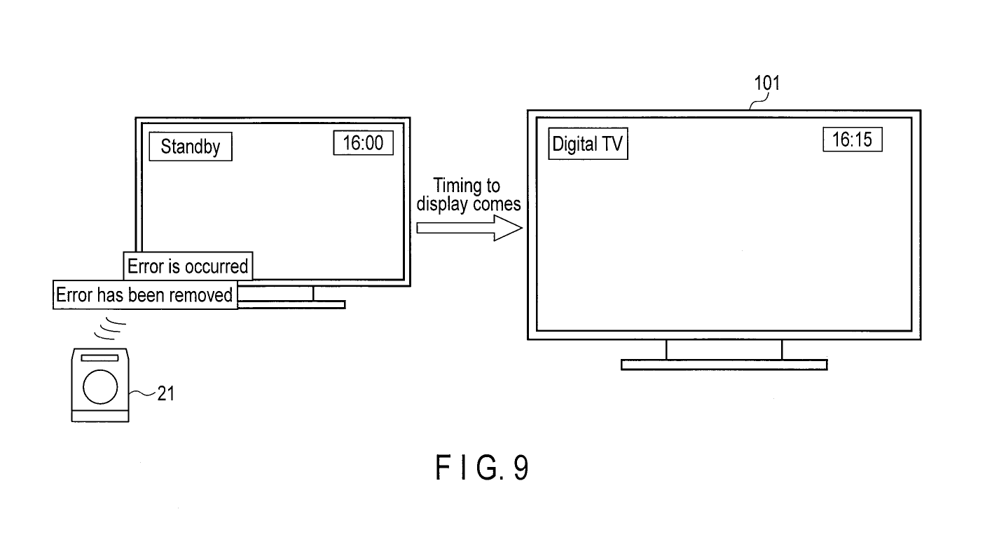

FIG. 9 shows a displaying example in a case where a plurality of notifications are received from the same apparatus in a period in which the notifications cannot be displayed and an error notification different from the “trouble notification” is included in the notifications.

Besides the above-described “notification of trouble (notification of first type)” and “notification of completion (second-type notification)”, “notification of error (third-type notification)” is defined as the types of the notifications from the household electrical appliances (ECHONET Lite conforming apparatuses). The “notification of error (third-type notification)” is, for example, a notification which results from unbalance of contents (washed articles) at the dehydration (step) in the washing machine 21, etc. At the dehydration (step) in the washing machine 21, for example, even if the operation (dehydration step) is temporarily stopped due to an influence from unbalance of the washed articles or the like, the error is often automatically solved owing to reduction of water according to the time elapse or the like. In this case, the “notification of error” and a “notification to cancel the notification of error” following the “notification of error” are notified from the washing machine 21. Thus, in the example of the television apparatus (displaying apparatus) shown in FIG. 12, when it is discriminated (detected) by the firmware of the CPU 151 in the controller 150 that the notification received by a near field communication processing module 190 via a near field communication communicating module 191 is a notification to cancel the notification held by the notification/time holding module 192, the television apparatus (displaying apparatus) does not display a content of the notification from the household electrical appliance, consequently.

The type of the household electrical appliance which has issued the notification may be added to the conditions for selecting the form of displaying the time information. For example, the form of displaying the time information can be varied according to the household electrical appliance, as the display for the “notification of completion”. The time when the notification is received can be used as the time information to be displayed when the notification from the lighting apparatus 41 is received, and the elapsing time can be used when the notification from the washing machine 21 is received, similarly to displaying

“notification from washing machine:

washing finished (15 minutes ago)”

when the notification from the washing machine is received and displaying

“notification from illumination:

illumination turned off (16:40)”

when the notification from the lighting apparatus is received.

In addition, the time elapsing from the time when the notification is received can be added to the conditions and, the elapsing time can be displayed if the elapsing time is short and the time when the notification is received can be displayed if the elapsing time is long. For example, the time when the notification is received can also be displayed, similarly to displaying

“notification from washing machine:

washing finished (15 minutes ago)”

when the notification is displayed within one hour from the reception of the notification and displaying

“notification from illumination:

illumination turned off (16:00)”

when the notification is displayed after one hour or more has elapsed since the reception of the notification.

In addition, the notification to be displayed can be identified in association with the notification type and the operating state of the displaying apparatus (television apparatus). In other words, the notification which should be definitely displayed is displayed irrespective of the operating state of the displaying apparatus while the notification which may not have to be displayed upon shifting to the displayable state is not displayed.

For example, the notification received when the operating state in which the displaying apparatus (television apparatus) is incapable of displacing the notification is VOD reproduction or the like (i.e., the main power supply of the displaying apparatus is turned on) is displayed when the displaying apparatus becomes capable of displacing the notification. As for the notifications received when the displaying apparatus is in the standby state, however, it is preferable to display the “notification of trouble(s)” alone and not to display the other notifications.

For example, even if the “notification of completion” indicating the completion of the operation of the washing machine which is operated during a sleeping time is displayed at turning on the television apparatus the next morning, the notification can be presumed to be unnecessary for the user. To the contrary, the “notification of trouble(s)” concerning a trouble which is presumed to require service (maintenance/inspection) should be displayed at turning on the television apparatus the next morning.

FIG. 12 shows examples of constituent elements in the television apparatus which can be employed as the displaying apparatus shown in FIG. 1 to FIG. 3 (FIG. 4 to FIG. 9).

The television apparatus 101 comprises an input module 111, a demodulator 112, a signal processor 113, an audio processor 121, a video processor 131, an OSD processor 132, a displaying processor 133, a controller 150, a storage 160, an operation input module 161, a receiving module 162, a network controller 171, a near field communication processing module, etc. The television apparatus 101 further comprises a speaker 122 and a display 134. The near field communication communicating module 191 and the notification/time holding module 192 are connected to the near field communication processing module 190. The near field communication processing module 190 is a communication unit/communication controller conforming to, for example, Wi-Fi direct or Bluetooth standard.

The television apparatus 101 receives a control input (operating instruction) from, for example, a remote controller 163 and supplies a control command corresponding to the operating instruction (control input) to the controller 150. For example, a standby (wait/main power off) state is shifted to the operating state by turning on a power button. The operating state is shifted to the standby state by turning on the power button again.

The input module 111 can receive digital broadcast signals which can be received via, for example, antenna ANT, for example, a broadcasting satellite (BS) broadcast signal and/or a communication satellite (CS) broadcast signal. The input module 111 can also receive a content (external input) supplied as an input directly or via, for example, a set top box (STB: or example, an external tuner corresponding to pay broadcast, etc. or a channel selector capable of selecting broadcast distributed by a cable distributor) or the like.

The input module 111 executes tuning (selection) of the received digital broadcast signal. The input module 111 supplies the tuned digital broadcast signal to the demodulator 112. The television apparatus 101 may comprise a plurality of input modules (tuners) 111. In this case, the television apparatus 101 can simultaneously receive a plurality of digital broadcast signals/contents. The input module 111 supplies the external input received via the STB or the like to the demodulator 112 as it is.

The demodulator 112 demodulates the selected digital broadcast signal/content. In other words, the demodulator 112 acquires moving image data (hereinafter called a stream) such as a transport stream (TS) from the digital broadcast signal/content. The demodulator 112 inputs the acquired stream in the signal processor 113. The television apparatus 101 may comprise a plurality of demodulators 112. The plurality of demodulators 112 can demodulate the plurality of digital broadcast signals/contents, respectively.

The signal processor 113 separates the stream demodulated by the demodulator 112 into, for example, a speech component, an image component, character information and a data component for an electric program guide (EPG). In other words, the signal processor 113 separates the stream into a digital image signal, a digital speech signal, and the other data signal such as, for example, the above-described component for the EPG, and text data including characters and codes called data broadcast, etc. The signal processor 113 can separate a plurality of streams demodulated by the plurality of demodulators 112.

In addition, the signal processor 113 supplies the separated digital speech signal to the audio processor 121. Also, the signal processor 113 supplies the separated digital image signal to the video processor 131, and supplies the data signal such as the EPG data to the controller 150.

The signal processor 113 can convert the stream into data (recording stream) in a recordable state under control of the controller 150. The signal processor 113 can further supply the recording stream to the storage 160 or the other module under control of the controller 150.

Moreover, the signal processor 113 can convert (transcode) an originally set bit rate (broadcast signal/content) into the other bit rate, as a bit rate of the stream. In other words, the signal processor 113 can transcode (convert) the original bit rate of the acquired broadcast signal/content into a bit rate which is lower as compared with the original bit rate. The signal processor 113 can thereby record the content (program) in a state of a small volume.

The audio processor 121 converts the digital speech signal received from the signal processor 113 into a signal (audio signal) of a format reproducible at the speaker 122. In other words, the audio processor 121 comprises a digital to analog (D/A) converter and converts the digital speech signal into an analog audio (acoustic)/speech signal. The audio processor 121 supplies the converted audio (acoustic)/speech signal to the speaker 122. The speaker 122 reproduces speech and an acoustic sound from the supplied audio (acoustic)/speech signal.

The video processor 131 converts the digital image signal received from the signal processor 113 into an image signal of a format reproducible at the display 134. In other words, the video processor 131 decodes the digital image signal received from the signal processor 113 to the image signal of a format reproducible at the display 134. The video processor 131 outputs the decoded image signal to the displaying processor 133.

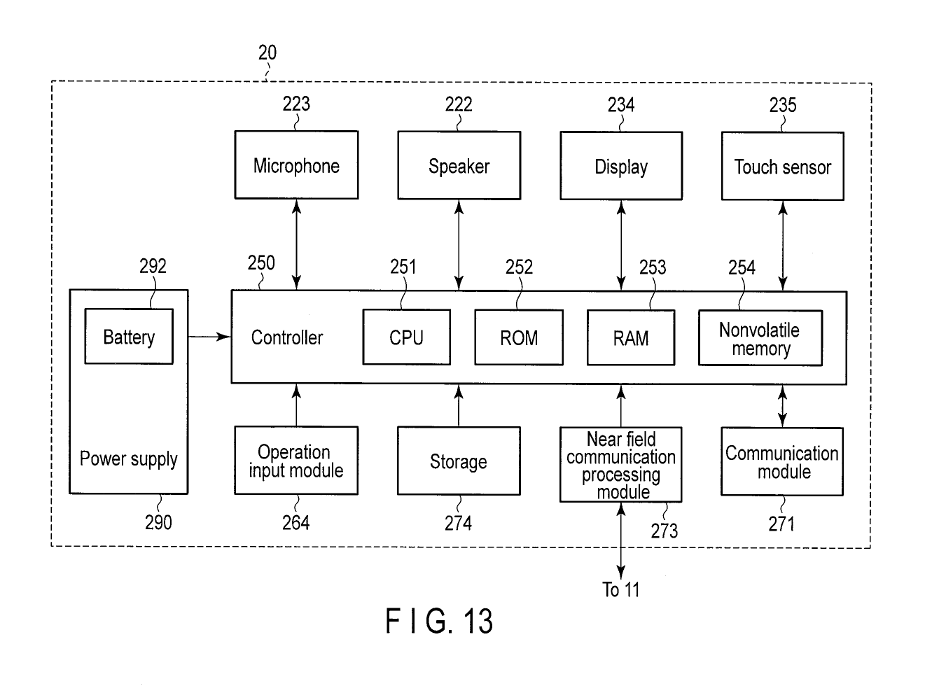

Based on the data signal supplied from the signal processor 113 and/or the control signal (control command) supplied from the controller 150, the OSD processor 132 produces an on screen display (OSD) signal to superpose notice information, etc., such as graphical user interface (GUI) display, subtitle display, presence/absence (no display) of arrival of social networking service (SNS) at a tablet terminal device (i.e., a portable terminal device shown in FIG. 13) 201, or arrival of image and audio speech communication which is being reproduced or communication data based on the communication, on the display signal from the video processor 131, and then display the notice information, etc.

The displaying processor 133 processes the received image signal by image quality adjustment of, for example, color, brightness, sharpness, contrast, etc., under control of, for example, the controller 150. The displaying processor 133 supplies the image signal subjected to the image quality adjustment to the display 134. Accordingly, the display 134 displays an image based on the supplied image signal.

The displaying processor 133 also superposes the display signal from the video processor 131 subjected to the image quality adjustment on the OSD signal from the OSD processor 132, and supplies the display signal to the display 134.

The display 134 comprises a liquid crystal display panel comprising, for example, a plurality of pixels arrayed in a matrix, a liquid crystal display device comprising a backlight which illuminates the liquid crystal display panel, etc. The display 134 displays the image based on the image signal supplied from the displaying processor 133.

The television apparatus 101 may be configured to comprise an output terminal which outputs the image signal, instead of the display 134. In addition, the television apparatus 101 may be configured to comprise an output terminal which outputs the audio signal, instead of the speaker 122. The television apparatus 101 may be configured to comprise an output terminal which outputs the digital image signal and the digital speech signal.

The controller 150 controls operations of each module in the television apparatus 101. The controller 150 comprises a central processing unit (CPU) 151, a read only memory (ROM) 152, a random access memory (RAM) 153, a nonvolatile memory (EEPROM) 154, etc. The controller 150 also executes various types of processing, based on an operation signal supplied from the operation input module 161. The controller 150 can obtain (compute) an elapsing time, based on the time information (i.e., the above-described clock function or time) at the time when the predetermined notification has been received from the household electrical appliance conforming to ECHONET Lite and the time information at the time when the notification becomes capable of being displayed. The computation of the elapsing time may be executed by firmware of the CPU 151 to be described below.

The CPU 151 comprises a computing element configured to execute various types of computation, etc. The CPU 151 implements various functions by executing the programs held by the ROM 152, the EEPROM 154 or the like. The CPU 151 is often charged with the above-described computation of the elapsing time.

The ROM 152 holds a program to control the television apparatus 101, a program to implement various functions, etc. The CPU 151 activates the programs stored in the ROM 152, based on an operation signal supplied from the operation input module 161. The controller 150 thereby controls the operation of each of the modules.

The RAM 153 functions as a work memory of the CPU 151. In other words, the RAM 153 stores the computation result of the CPU 151, data read by the CPU 151, etc.

The EEPROM 154 is a nonvolatile memory configured to store various types of setting information and programs, etc. The EEPROM 154 holds information of a client device authenticated by the near field communication processing module 190 (under control of the controller 150) as needed.

The storage 160 comprises a storage medium configured to store a content. The storage 160 is, for example, a hard disk drive (HDD), a solid state drive (SSD), a semiconductor memory or the like. The storage 160 can store a recorded stream, text data, etc. supplied from the signal processor 113.

The operation input module 161 includes, for example, an operation key for producing an operation signal in response to a user's operation input. The operation input module 161 may be configured to receive an operation signal from a keyboard, a mouse, or other input device. The operation input module 161 supplies the operation signal to the controller 150.

The display 134 of the television apparatus 101 may be configured to comprise a touch panel function which enables some of functions of the operation input module 161 to be implemented.

The receiving module 162 comprises a sensor configured to receive an operation signal supplied from a remote controller 163 in, for example, an infra-red (Ir) system, etc. The receiving module 162 supplies the received signal to the controller 150. The controller 150 receives the signal supplied from the receiving module 162, amplifies the received signal, and executes analog to digital (A/D) conversion of the received signal to decode the original operation signal sent from the remote controller 163.

The remote controller 163 produces the operation signal based on the user's operation input. The remote controller 163 sends the produced operation signal to the receiving module 162 by infra-red communication. The receiving module 162 and the remote controller 163 may be configured to send and receive the operation signal by other wireless communication using radio wave (RF), and the like.

The network controller 171 can connect with the network (Internet) 1 and communicate with the other devices on the network 1. The television apparatus 101 can thereby receive/send information from/to an arbitrary device connectable via the network 1, a content supplier, or various data servers. The television apparatus 101 can thereby obtain and reproduce a content (stream) held by the content supplier or data server connected via the network controller 171, and/or an arbitrary home device. The content supplier connected with the network controller 171 often has great resource load that limits a displaying capacity of, for example, the VOD content, of the television apparatus 101 (i.e., prevents the notification from the household electrical appliance from being displayed).

An HDMI processor 181 executes sending and receiving the control signal, image (video) data and speech (acoustic/audio) data, under HDMI (registered trademark) standard (i.e., high definition multimedia interface (HDMI)). The HDMI processor 181 can send/receive a content (stream) including images and speech to/from an external device or a large-capacity memory (external HDD) comprising an HDMI terminal. The external device is, for example, a Blu-ray (registered trademark) recorder, a digital versatile disk (DVD) recorder, a hard disk (HDD) recorder, an HDMI linkage device connectable with the other device under HDMI standard, and/or a network attached storage (NAS). The television apparatus 101 can comprise other interfaces such as a LAN terminal connectable under, for example, serial-advanced technology attachment (Serial-ATA) and HDMI-HEC (HDMI Ethernet Channel).

The near field communication processing module 190 is charged with sending/receiving data to/from the household electrical appliances (21, 31, 41, 51) connected via the near field communication communicating module 191 (receiving the notification from the household electrical appliances), mutual authentication with counterpart devices (household electrical appliances), etc. Information acquired from the authenticated counterpart devices is stored in, for example, the notification/time holding module 192 or the EEPROM 154. The near field communication communicating module 191 and the near field communication processing module 190 are provided independently of the network controller 171 in FIG. 11, but may be formed integrally with (or partially shared with) the network controller 171. If the network controller 171 is formed integrally with the near field communication communicating module 191 and the near field communication processing module 190, the notification/time holding module 192 is connected to the network controller 171.

FIG. 13 shows examples of constituent elements of a portable terminal apparatus available as the displaying apparatus shown in FIG. 1 to FIG. 3 (FIG. 4 to FIG. 9). Today the displaying apparatus is not necessarily limited to the television apparatus, but is also considered as a tablet apparatus or a smartphone.

A portable terminal apparatus 201 comprises a controller 250, an operation input module 264, a communication module 271, a near field communication processing module 273 and a storage 274. The near field communication processing module 273 is, for example, a communication unit/communication controller conforming to Wi-Fi direct or Bluetooth standard.

The portable terminal apparatus 201 also comprises a speaker 222, a microphone 223, a display 234, and a touch sensor 235 (integral with the display 234).

The controller 250 controls operations of each of the modules in the portable terminal apparatus 201. The controller 250 comprises a CPU 251, a ROM 252, a RAM 253, a nonvolatile memory 254, etc.

The controller 250 executes various types of processing, based on operation signals supplied from the operation input module 264 or the touch sensor 235. The controller 250 also allows notifications sent from the household electrical appliances 21, 31, 41 and 51, etc. via the near field communication processing module 273 to be displayed on the display 234. The notifications acquired via the near field communication processing module 273 are not displayed while the portable terminal apparatus 201 connects with the network and is downloading the content (if resource load of downloading, etc. is great, the notifications are displayed after the downloading is ended).

The CPU 251 executes various types of computation processing. The CPU 251 implements various functions by executing programs held by the ROM 252 or the nonvolatile memory 254.

The ROM 252 holds programs to control the television apparatus 101, programs to implement various functions, etc. The CPU 251 activates the programs stored in the ROM 252, based on operation signals from the operation input module 264. The controller 250 thereby controls the operations of each of the modules.

The RAM 253 functions as a work memory of the CPU 251. In other words, the RAM 253 stores computation results of the CPU 251, data read via the CPU 251, data necessary for authentication made for modules such as the household electrical appliances 21, 31, 41 and 51 by the near field communication processing module 273, etc.

The nonvolatile memory 254 stores various types of setting information, programs, authentication results of the respective household electrical appliances made by the near field communication processing module 273, etc.

In addition, the controller 250 can produce image signals for display to execute various screen displays and display images on the display 234, in accordance with the applications executed by the CPU 251. Accordingly, the display 234 reproduces moving images (graphic), still images, character information, etc., based on supplied moving image signals (video). The controller 250 can also produce speech signals for reproduction such as various types of speech, etc. and output the speech from the speaker 222, in accordance with the applications executed by the CPU 251. Accordingly, the speaker 222 reproduces sounds (acoustics/speech), based on the supplied audio signals (Audio).

The microphone 223 collects sounds around the portable terminal apparatus 201 and produces acoustic signals. After subjected to A/D conversion, the acoustic signals are converted into acoustic data by the controller 250 and temporarily stored in the RAM 253. The acoustic data is converted into (reproduced as) speech/acoustic sound by the speaker 222, after subjected to D/A conversion, as needed. The acoustic data is also used as a control command by the speech recognition after subjected to the A/D conversion.

The display 234 includes, for example, a liquid crystal display device which comprises a liquid crystal display panel comprising a plurality of pixels arrayed in a matrix and a backlight configured to illuminate the liquid crystal panel, etc.

The touch sensor 235 produces an operation signal, based on an on-screen operation displayed on the display 234 (i.e., the user input corresponding to the screen display), and supplies the operation signal to the controller 250.

The operation input module 264 comprises, for example, a key to produce an operation signal according to a user's operation input. The operation input module 264 comprises, for example, a volume adjustment key to adjust a volume, a brightness adjustment key to adjust a display brightness of the display 234, a power key to switch (turn on/off) a power state of the portable terminal apparatus 201, etc. The operation input module 264 may be configured to receive an operation signal from the keyboard, the mouse, or the other input device capable of producing the operation signal. For example, when the portable terminal apparatus 201 comprises a USB terminal, a module conforming to Bluetooth standard, etc., the operation input module 264 receives an operation signal from an input device connected by USB or Bluetooth and supplies the operation signal to the controller 250.

The communication module 271 can communicate with the other devices on the network 1 by LAN or wireless LAN. The portable terminal apparatus 201 can thereby acquire and reproduce contents (streams) held by content suppliers or data servers connected via the network 1 or arbitrary devices including home devices.

The near field communication processing module 273 is charged with sending/receiving data to/from each of the household electrical appliances 21, 31, 41 and 51, and processing the data. In other words, the portable terminal apparatus 201 can display on the display 234 the notifications received from the household electrical appliances (ECHONET Lite-compatible devices) by the communication made with each of the household electrical appliances 21, 31, 41 and 51 by the near field communication processing module 273.

The storage 274 includes a hard disk drive (HDD), a solid state drive (SSD), or a semiconductor memory. The storage 274 can store programs executed by the CPU 251 of the controller 250, applications, contents such as moving images, various data elements, etc.

A power supply module 290 comprises a battery (rechargeable battery) 292, and a terminal (for example, a DC jack) to connect with an adapter by which an electric power is received from a commercial power supply, etc. The power supply module 290 charges the battery 292 with the electric power received from the commercial power supply. In addition, the power supply module 290 supplies the electric power with which the battery 292 is charged to each of the modules in the portable terminal apparatus 201.

Thus, by storing the times when the notification is received from the household electrical appliance conforming to ECHONET Lite, and simultaneously displaying the notification and the time information based on the time, the displaying apparatus can display the notification received in the period in which the notification cannot be displayed so as to allow the user to know when the notification is received.

In addition, if the displaying apparatus receives a plurality of notifications in the period in which the notifications cannot be displayed, the displaying apparatus can execute necessary displaying alone. A list of the history of the plurality of notifications can also be displayed.

In other words, by the (selectable) displaying method of executing the whole display of the same device, the displaying apparatus can notify the user of the current situation (operation state) of the household electrical appliance, of displaying the notification which should be definitely displayed is displayed irrespective of the operation state of the displaying apparatus, not displaying the notification which can be assumed to be a notification that does not need to be displayed at the time of shifting to the displayable state, etc.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a notification receiving module configured to receive a notification from a counterpart communication apparatus;
a notification holding module configured to acquire time information that the notification receiving module has received the notification and to hold the time information in association with the notification;
a notification type discriminating module configured to discriminate a type of the notification received by the notification receiving module;
a displaying control module configured to cause a display to display a content of the notification including the time information, based on the time information; and
a displaying setting module configured to set a display format of the time information based on a discrimination result of the notification type discriminating module.

2. The electronic device of claim 1, wherein the displaying setting module configured to set a first display format of displaying a time indicated by the time information that the notification receiving module has received the notification as it is, and configured to set a second display format of displaying a time elapsing from the time indicated by the time information that the notification receiving module has received the notification.

3. The electronic device of claim 2, wherein the displaying setting module configured to set the first display format if the notification indicates at least one of a trouble and an error, and configured to set the second display format if the notification indicates a completion of predetermined processing.

4. The electronic device of claim 2, wherein the displaying setting module configured to set a third display format of not displaying the notification held by the notification holding module, based on the discrimination result of the notification type discriminating module.

5. The electronic device of claim 1, wherein the notification holding module configured to hold the notification if notification holding module is in an operation state of being incapable of immediately displaying the notification received by the notification receiving module.

6. The electronic device of claim 5, wherein if the notification receiving module configured to receive a plurality of notifications, the displaying setting module configured to set displaying a last received notification alone.

7. The electronic device of claim 5, wherein if the notification receiving module configured to receive a plurality of notifications, displaying the received notifications altogether is set.

8. A method for displaying comprising:
receiving a notification from a counterpart apparatus;
acquiring time information that the notification has been received;
holding the time information and the notification in association with each other to display the time information and the notification at the time of being capable of displaying; and
setting a display format of displaying the notification, based on a notification type.
